(19) United States
(12) Patent Application Publication
(10) Pub. No.: US 2026/0283103 A1
(43) Pub. Date: Sep. 24, 2026

(54) PET FENCE

(71) Applicant: JIANGSU ZHONGHENG PET ARTICLES JOINT-STOCK CO., LTD., Yancheng City (CN)

(72) Inventor: Bin QIU, Yancheng City (CN)

(21) Appl. No.: 19/430,891

(22) Filed: Dec. 23, 2025

(30) Foreign Application Priority Data
Mar. 19, 2025 (CN) 202520487463.9

(51) Int. Cl. A01K 1/03

(52) U.S. Cl. CPC A01K 1/031

(57) ABSTRACT

Provided is a pet fence, including: a plurality of fence sections connected end to end in sequence to define an accommodating space, where an access opening is provided on one of the plurality of fence sections, and the plurality of fence sections are telescopic; a door assembly connected to the access opening; limiting assemblies respectively arranged in the plurality of fence sections; and connection assemblies each arranged between two adjacent fence sections of the plurality of fence sections.

### CROSS REFERENCE TO THE RELATED APPLICATIONS

This application is based upon and claims priority to Chinese Patent Application No. 202520487463.9, filed on Mar. 19, 2025, the entire contents of which are incorporated herein by reference.

### TECHNICAL FIELD

The present disclosure relates to the field of pet products, and specifically to a pet fence.

### BACKGROUND

Pet fences are typically enclosures used in families to confine pets, preventing the pets from escaping and becoming difficult to manage.

As different families have different apartment layouts, rooms for keeping pets are often of different shapes. For existing pet fences, the angles between fence sections of the pet fence are relatively fixed after the pet fence is mounted, and the shape of the pet fence cannot be changed to adapt to the actual shape of the room, limiting the range of applications of the pet fence.

### SUMMARY

To solve the technical problem that the range of applications of existing pet fences is limited because the angles between fence sections of the pet fence are relatively fixed after the pet fence is mounted and the shape of the pet fence cannot be changed to adapt to the actual shape of the room, an objective of the present disclosure is to provide a pet fence.

To achieve the above objective, an embodiment of the present disclosure provides a pet fence, including:

a plurality of fence sections, where the plurality of fence sections are connected end to end in sequence to define an accommodating space, an access opening is provided on one of the plurality of fence sections, and the plurality of fence sections are telescopic;

a door assembly, where the door assembly is connected to the access opening;

limiting assemblies, where the limiting assemblies are respectively arranged in the plurality of fence sections; and

connection assemblies, where each of the connection assemblies is arranged between two adjacent fence sections of the plurality of fence sections.

In the above technical solution, each of the plurality of fence sections includes:

a first horizontal tube;

two first vertical tubes, where an end of each of the two first vertical tubes is connected to the first horizontal tube;

two second vertical tubes, where the two second vertical tubes are slidably connected to interiors of the two first vertical tubes respectively; and

a second horizontal tube, where the second horizontal tube is connected to an end of each of the two second vertical tubes away from the first horizontal tube.

In the above technical solution, each of the plurality of fence sections further includes:

a first metal mesh, where the first metal mesh is connected between the two first vertical tubes;

a second metal mesh, where the second metal mesh is connected between the two second vertical tubes; and

first slide grooves, where the first slide grooves are respectively provided on opposing surfaces of the two first vertical tubes.

In the above technical solution, each of the plurality of fence sections further includes:

a first metal tube, where an end of the first metal tube is connected to the first horizontal tube; and

a second metal tube, where an end of the second metal tube is connected to the second horizontal tube, and the second metal tube is slidably connected to an interior of the first metal tube.

In the above technical solution, each of the limiting assemblies includes:

first limiting members, where the first limiting members are fixedly connected to interiors of the two second vertical tubes respectively, and the first limiting members penetrate the two second vertical tubes respectively; and

first through holes, where the first through holes are respectively provided on the two first vertical tubes, and the first limiting members are respectively arranged opposite to the first through holes.

In the above technical solution, each of the connection assemblies includes:

a first connection member, where the first connection member is connected to an adjacent end of the second horizontal tube of one of the two adjacent fence sections, a first connecting hole is provided on the first connection member, a plurality of first limiting holes are provided on the first connection member, and the plurality of first limiting holes are arranged along a circumferential direction of the first connecting hole;

a second connection member, where the second connection member is connected to an adjacent end of the second horizontal tube of the other of the two adjacent fence sections, a second connecting hole is provided on the second connection member, a plurality of second limiting holes are provided on the second connection member, and the plurality of second limiting holes are arranged along a circumferential direction of the second connecting hole;

a third connection member, where the third connection member is arranged between the two adjacent fence sections, and the third connection member is arranged on a side of the first connection member and the second connection member away from the first horizontal tube; and

at least two limiting rods, where the at least two limiting rods are connected to a side of the third connection member adjacent to the first horizontal tube, and each of the at least two limiting rods is configured to pass through one of the plurality of first limiting holes and one of the plurality of second limiting holes.

In the above technical solution, each of the connection assemblies further includes:

at least one connecting tube, where the at least one connecting tube is connected to a side of each of two adjacent first vertical tubes of the two adjacent fence sections away from a respective one of the first horizontal tube of one of the two adjacent fence sections and the first horizontal tube of the other of the two adjacent fence sections;

a second through hole, where the second through hole is provided on the third connection member;

a connecting rod, where the connecting rod is arranged between the two adjacent fence sections, and the connecting rod is configured to pass through the second through hole, the first connecting hole, the second connecting hole, and the at least one connecting tube; and

a second limiting member, where the second limiting member is arranged on a side of the third connection member away from the first horizontal tube, the second limiting member is connected to the connecting rod, and an outer diameter of the second limiting member is larger than an inner diameter of the second through hole.

In the above technical solution, each of the plurality of fence sections further includes:

protective members, where each of the protective members is connected to an end of a respective one of the two first vertical tubes away from the first horizontal tube, the two second vertical tubes respectively pass through the protective members, and a second slide groove is provided on a side of each of the protective members adjacent to the first metal mesh.

In the above technical solution, each of the plurality of fence sections further includes:

a fixing member, where two ends of the fixing member are respectively connected to the two first vertical tubes, and the first metal tube passes through the fixing member.

In the above technical solution, the connection assemblies respectively include:

fourth connection members, where each of the fourth connection members is arranged between the two adjacent fence sections, and two ends of each of the fourth connection members are respectively inserted into ends of two adjacent second vertical tubes of the two adjacent fence sections away from the first horizontal tube; and

fifth connection members, where each of the fifth connection members is arranged between the two adjacent fence sections, and two adjacent first vertical tubes of the two adjacent fence sections pass through each of the fifth connection members.

In the above technical solution, the pet fence further includes:

at least two supporting members, where two ends of each of the at least two supporting members are respectively connected to two of the fourth connection members, and the at least two supporting members are parallel to each other.

In the above technical solution, the door assembly includes:

a third horizontal tube, where the third horizontal tube is arranged on an inner side of the access opening, and the third horizontal tube is connected to the first horizontal tube of the one of the plurality of fence sections;

a fourth horizontal tube, where the fourth horizontal tube is arranged on the inner side of the access opening, and the fourth horizontal tube is connected to the second horizontal tube of the one of the plurality of fence sections; and

a rotary door, where two ends of the rotary door are rotatably connected to the third horizontal tube and the fourth horizontal tube respectively.

In the above technical solution, the door assembly further includes:

a plurality of first supporting rods, where the plurality of first supporting rods are arranged on two sides of the rotary door, and an end of each of the plurality of first supporting rods is connected to the third horizontal tube;

a plurality of second supporting rods, where the plurality of second supporting rods are arranged on the two sides of the rotary door, a first end of each of the plurality of second supporting rods is connected to the fourth horizontal tube, and a second end of each of the plurality of second supporting rods is slidably connected to an interior of a respective one of the plurality of first supporting rods; and

a locking member, where the locking member is threadedly connected to an outer wall of a first supporting rod of the plurality of first supporting rods.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure will become apparent and comprehensible from the description of embodiments made in connection with the accompanying drawings, in which:

FIG. 1 is an overall schematic structural diagram of Embodiment 1 of the present disclosure.

FIG. 2 is a schematic structural diagram of two adjacent fence sections that are connected according to Embodiment 1 of the present disclosure.

FIG. 3 is a schematic structural diagram of a door assembly according to Embodiment 1 of the present disclosure.

FIG. 4 is a schematic structural enlarged view of part E according to Embodiment 1 of the present disclosure.

FIG. 5 is a schematic structural diagram of a connection assembly and a connecting rod according to Embodiment 1 and Embodiment 2 of the present disclosure.

FIG. 6 is a schematic structural enlarged view of part A according to Embodiment 1 and Embodiment 2 of the present disclosure.

FIG. 7 is a schematic structural diagram of a first vertical tube and a second vertical tube according to Embodiment 1 and Embodiment 2 of the present disclosure.

FIG. 8 is a schematic structural enlarged view of part B according to Embodiment 1 and Embodiment 2 of the present disclosure.

FIG. 9 is a schematic structural diagram of a first vertical tube according to Embodiment 1 and Embodiment 2 of the present disclosure.

FIG. 10 is a schematic structural diagram of a protective member according to Embodiment 1 of the present disclosure.

FIG. 11 is a schematic structural diagram of a third connection member according to Embodiment 1 and Embodiment 2 of the present disclosure.

FIG. 12 is a schematic structural diagram of a first connection member according to Embodiment 1 and Embodiment 2 of the present disclosure.

FIG. 13 is a schematic structural diagram of a second connection member according to Embodiment 1 and Embodiment 2 of the present disclosure.

FIG. 14 is an overall schematic structural diagram of Embodiment 2 of the present disclosure.

FIG. 15 is a schematic structural diagram of two adjacent fence sections that are connected according to Embodiment 2 of the present disclosure.

FIG. 16 is an overall schematic structural diagram of Embodiment 3 of the present disclosure.

FIG. 17 is a schematic structural enlarged view of part C according to Embodiment 3 of the present disclosure.

FIG. 18 is a schematic structural enlarged view of part D according to Embodiment 2 of the present disclosure.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

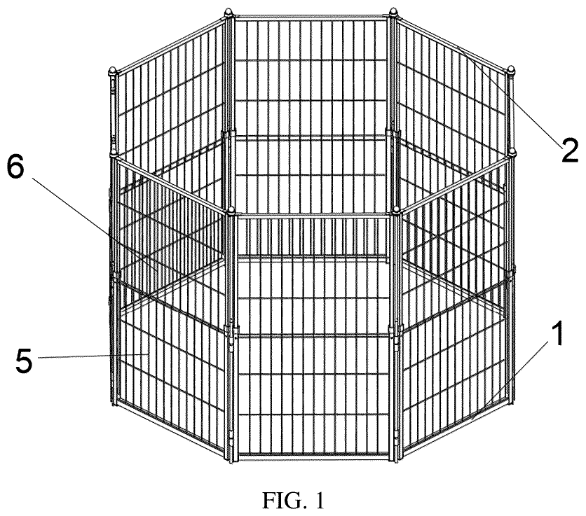

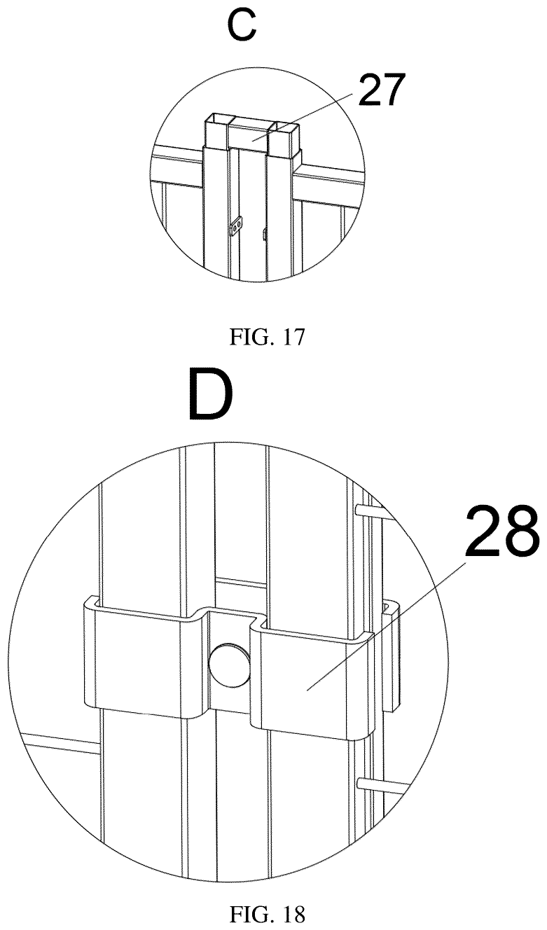

Some embodiments of a pet fence of the present disclosure will be described below with reference to FIG. 1 to FIG. 18.

As shown in FIG. 1 to FIG. 18, an embodiment of the present disclosure provides a pet fence, including a plurality of fence sections, a door assembly, limiting assemblies, and connection assemblies.

Specifically, the plurality of fence sections are connected end to end in sequence to define an accommodating space. An access opening is provided on one of the plurality of fence sections. The door assembly is rotatably connected to the access opening. The limiting assemblies are respectively arranged in the plurality of fence sections. Each of the connection assemblies is arranged between two adjacent fence sections of the plurality of fence sections.

Before the pet fence is mounted, the fence sections are in a retracted state. In the retracted state, storage space can be reduced and space utilization can be improved. When the pet fence needs to be mounted, the fence sections are extended, and then the fence sections are fixed using the limiting assemblies to prevent the fence sections from retracting again, thereby improving the stability of the fence sections. The fence sections are connected together using the connection assemblies, and the angle between two adjacent fence sections can be adjusted during the connection process, so that the mounted pet fence can be of different shapes to adapt to rooms or other spaces of different shapes, thereby expanding the range of applications of the pet fence.

### Embodiment 1

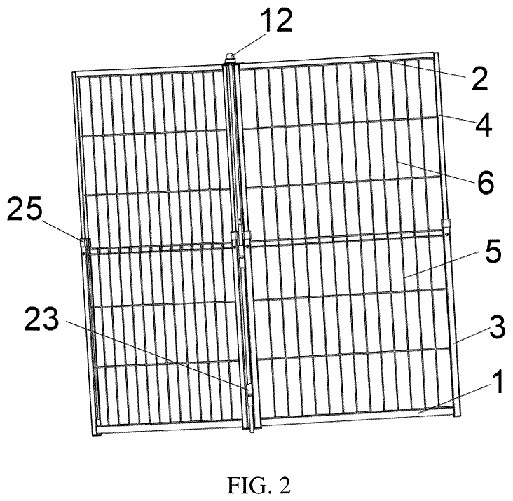

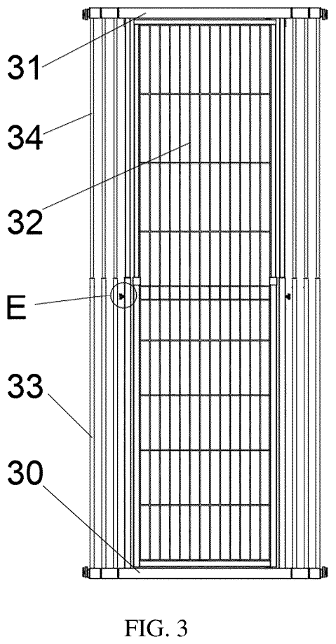

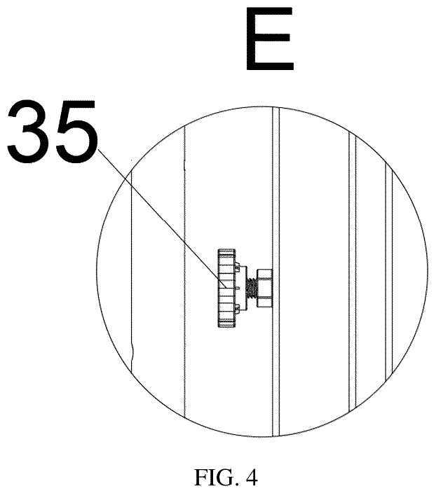

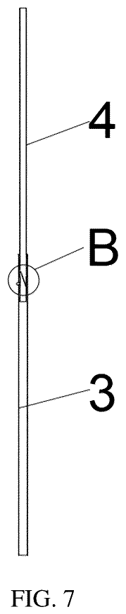

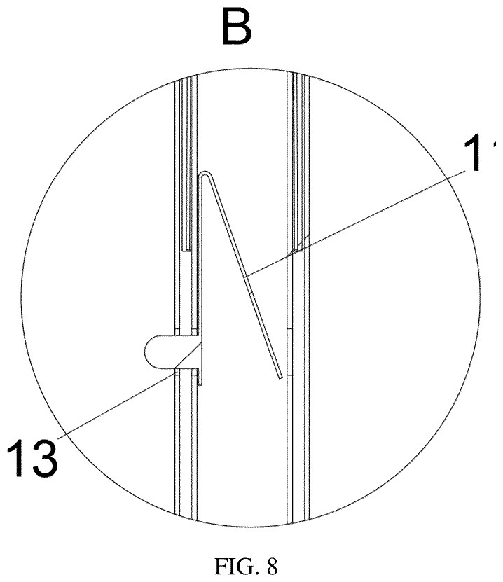

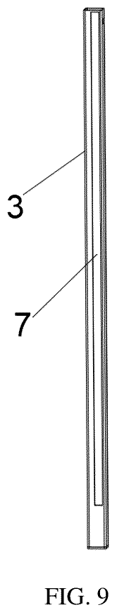

As shown in FIG. 1, FIG. 2, FIG. 3, FIG. 4, FIG. 7, FIG. 8, and FIG. 9, in an embodiment of the present disclosure, each of the plurality of fence sections includes:

a first horizontal tube 1;

two first vertical tubes 3, where lower ends of the two first vertical tubes 3 are respectively connected to two ends of the first horizontal tube 1;

two second vertical tubes 4, where the two second vertical tubes 4 are slidably connected to interiors of the two first vertical tubes 3 respectively; and

a second horizontal tube 2, where two ends of the second horizontal tube 2 are fixedly connected to upper ends of the two second vertical tubes 4 respectively.

Each of the plurality of fence sections further includes:

a first metal mesh 5, where two ends of the first metal mesh 5 in a horizontal direction are fixedly connected to opposing surfaces of the two first vertical tubes 3 respectively, and a lower end of the first metal mesh 5 is fixedly connected to an upper end of the first horizontal tube 1;

a second metal mesh 6, where two ends of the second metal mesh 6 in the horizontal direction are fixedly connected to opposing surfaces of the two second vertical tubes 4 respectively, and an upper end of the second metal mesh 6 is fixedly connected to a lower end of the second horizontal tube 2; and

first slide grooves 7, where the first slide grooves 7 are respectively provided on the opposing surfaces of the two first vertical tubes 3.

Each of the limiting assemblies includes first limiting members 11 and first through hole 13.

Each of the first limiting members 11 may be a V-shaped elastic piece. The V-shaped elastic piece is fixedly connected to an interior of a respective second vertical tube 4 of the two second vertical tubes 4. A protrusion is fixedly connected to the V-shaped elastic piece. The protrusion penetrates the respective second vertical tube 4.

The first through holes 13 are respectively provided on the two first vertical tubes 3. The protrusion on the V-shaped elastic piece is arranged opposite to a respective one of the first through holes 13.

The door assembly includes:

a third horizontal tube 30, where the third horizontal tube 30 is arranged on an inner side of the access opening, and two ends of the third horizontal tube 30 are fixedly connected to portions of the first horizontal tube 1 of the one of the plurality of fence sections on two sides of the access opening respectively;

a fourth horizontal tube 31, where the fourth horizontal tube 31 is arranged on the inner side of the access opening, and two ends of the fourth horizontal tube 31 are fixedly connected to portions of the second horizontal tube 2 of the one of the plurality of fence sections on the two sides of the access opening respectively; and

a rotary door 32, where a lower end and an upper end of the rotary door 32 are rotatably connected to the third horizontal tube 30 and the fourth horizontal tube 31 respectively.

The door assembly further includes:

a plurality of first supporting rods 33, where the plurality of first supporting rods 33 are arranged on two sides of the rotary door 32, a lower end of each of the plurality of first supporting rods 33 is fixedly connected to the third horizontal tube 30, and a slide rail is provided in each of the plurality of first supporting rods 33;

a plurality of second supporting rods 34, where the plurality of second supporting rods 34 are arranged on the two sides of the rotary door 32, an upper end of each of the plurality of second supporting rods 34 is fixedly connected to the fourth horizontal tube 31, and a lower end of each of the plurality of second supporting rods 34 is slidably connected to the slide rail in a respective one of the plurality of first supporting rods 33; and

a locking member 35, where the locking member 35 is threadedly connected to an outer wall of a first supporting rod 33 of the plurality of first supporting rods 33.

Before the pet fence is mounted, the two second vertical tubes 4 are respectively arranged in the two first vertical tubes 3, the two ends of the second metal mesh 6 respectively pass through the first slide grooves 7 on the opposing surfaces of the two first vertical tubes 3, and the two ends of the second metal mesh 6 respectively extend into the two first slide grooves 7. In this case, a length of the entire structure of the fence section is less than a length of the fence section when in use, so that the storage space required by the fence sections can be reduced and space utilization can be improved.

To mount the pet fence, the second horizontal tube 2 is pulled upward to drive the second vertical tubes 4 to slide upward, and at the same time, cause the second metal mesh 6 to slide upward along the first slide grooves 7. During the upward movement of the second vertical tube 4, because the protrusion penetrates the second vertical tube 4 and is in contact with an inner wall of the first vertical tube 3, and the V-shaped elastic piece is always in a compressed state and applies a force to the protrusion during the upward sliding of the second vertical tube 4, the protrusion applies a force to the first vertical tube 3. Then, when a lower end of the second vertical tube 4 is about to reach an upper end of the first vertical tube 3, the protrusion moves to the first through hole 13, and the V-shaped elastic piece restores to the original shape and drives the protrusion to pass through the first through hole 13. As such, the second vertical tube 4 can be fixed through the engagement of the first through hole 13 with the protrusion to prevent the second vertical tube 4 from moving relative to the first vertical tube 3, thereby improving the stability of the first vertical tube 3 and the second vertical tube 4. When a surface of the protrusion is an arc-shaped surface, the second horizontal tube 2 may be directly pushed downward. After the protrusion is compressed, the protrusion compresses the V-shaped elastic piece, and the protrusion enters the second vertical tube 4 again through the through hole. Then, the second horizontal tube 2 is further pushed downward, and the second vertical tube 4 will enter the first vertical tube 3 again.

In the process of pulling the second horizontal tube 2 upward, the second horizontal tube 2 drives the fourth horizontal tube 31 to move upward, and the fourth horizontal tube 31 drives the second supporting rods 34 to move upward. The rotary door 32 is telescopic. The principles of extension and retraction of the rotary door 32 are the same as those of the fence section, so the details will not be described herein again. As such, in the process of pulling the second horizontal tube 2 upward, the rotary door 32 can be driven to extend. After the entire pet fence is mounted, a pet can enter and exit the pet fence through the rotary door 32.

After the position of the rotary door 32 is determined, the locking member 35 may be rotated. The locking member 35 may be a screw. The screw may be rotated to penetrate a side wall of the first supporting rod 33 and extend into the slide rail, so that an end portion of the screw comes into contact with the second supporting rod 34. After the screw is tightened, the second supporting rod 34 can be fixed by the screw to prevent the second supporting rod 34 from loosening.

As shown in FIG. 1 to FIG. 4 as well as FIG. 9 to FIG. 11, in an embodiment of the present disclosure, each of the connection assemblies includes a first connection member 15, a second connection member 16, a third connection member 17, and two limiting rods 22.

The first connection member 15 is fixedly connected to an adjacent end of the second horizontal tube 2 of one of the two adjacent fence sections. The first connection member 15 includes a first rectangular piece and a first round piece. The first rectangular piece is fixedly connected to the adjacent end of the second horizontal tube 2. The first round piece is not in contact with the second horizontal tube 2. A first connecting hole 18 is provided in a middle portion of the first round piece. A plurality of first limiting holes 20 are provided on the first round piece. The plurality of first limiting holes 20 are arranged at equal intervals along a circumferential direction of the first connecting hole 18.

The second connection member 16 is fixedly connected to an adjacent end of the second horizontal tube 2 of the other of the two adjacent fence sections. The second connection member 16 includes a second rectangular piece and a second round piece. The second rectangular piece is fixedly connected to the adjacent end of the second horizontal tube 2. The second round piece is not in contact with the second horizontal tube 2. A second connecting hole 19 is provided in a middle portion of the second round piece. The second round piece is provided with a plurality of second limiting holes 21. The plurality of second limiting holes 21 are arranged at equal intervals along a circumferential direction of the second connecting hole 19.

The third connection member 17 is arranged between the two adjacent fence sections. The third connection member 17 is arranged on a side of the first connection member 15 and the second connection member 16 away from the first horizontal tube 1.

The two limiting rods 22 are fixedly connected to a side of the third connection member 17 adjacent to the first horizontal tube 1. Each of the two limiting rods 22 is configured to pass through one of the plurality of first limiting holes 20 and one of the plurality of second limiting holes 21.

After the mounting of the first vertical tubes 3 and the second vertical tubes 4 is completed, for example, the pet fence of the present disclosure includes eight fence sections, namely, a #1fence section, a #2 fence section, a #3 fence section, a #4 fence section, a #5 fence section, a #6fence section, a #7 fence section, and a #8 fence section. Second horizontal tubes 2 of the #1 fence section, the #2 fence section, the #3 fence section, the #4 fence section, the #5 fence section, the #6 fence section, the #7 fence section, and the #8 fence section are respectively defined as a #1 second horizontal tube 2, a #2 second horizontal tube 2, a #3 second horizontal tube 2, a #4 second horizontal tube 2, a #5 second horizontal tube 2, a #6 second horizontal tube 2, a #7 second horizontal tube 2, and a #8 second horizontal tube 2. When the eight fence sections are mounted, the first round piece on the #1 second horizontal tube 2 and the second round piece on the #2 second horizontal tube 2 are stacked together in a vertical direction. The first round piece is arranged on an upper surface of the second round piece. The shape and size of the first round piece are the same as the shape and size of the second round piece. The shape, size, and number of the first connecting hole(s) 18 on the first round piece are the same as the shape, size, and number of the second connecting hole(s) 19 on the second round piece. The shape, size, and number of the first limiting holes 20 on the first round piece are the same as the shape, size, and number of the second limiting holes 21 on the second round piece. For example, in the present disclosure, eight first limiting holes 20 and eight second limiting holes 21 are provided. An angle formed by two lines respectively connecting a circle center of the first connecting hole 18 to circle centers of two adjacent first limiting holes 20 is 45 degrees. The #1 fence section and the #2 fence section are arranged side by side, so that the #1 fence section and the #2 fence section are on the same straight line. In this case, an angle formed by the #1 fence section and the #2 fence section is 180 degrees, and the eight first limiting holes 20 are respectively opposite to the eight second limiting holes 21 in the vertical direction. Each of the two limiting rods 22 on the third connection member 17 is passed through one pair of the first limiting hole 20 and the second limiting hole 21 that are opposite to each other. Through the respective engagement of the two limiting rods 22 with two pairs of the first limiting holes 20 and the second limiting holes 21, the first round piece and the second round piece can be limited from moving relative to each other, and the angle formed by the #1 fence section and the #2 fence section can be set to 180 degrees. As such, the stability of connection between the #1 fence section and the #2 fence section is improved, and the #1 fence section and the #2 fence section are prevented from moving relative to each other. In addition, the angle between the #1 fence section and the #2 fence section may also be 135 degrees, which can be achieved by rotating the #1 fence section toward the #2 fence section by 45 degrees based on the case where the angle between the #1 fence section and the #2 fence section is 180 degrees. In this case, the eight first limiting holes 20 are also respectively opposite to the eight second limiting holes 21, and the two limiting rods 22 may be respectively inserted into two pairs of the first limiting holes 20 and the second limiting holes 21 that are opposite to each other. Similarly, the angle formed by the #1 fence section and the #2 fence section may also be set to 90 degrees or 45 degrees. Then, by the above mounting method, the #2 fence section and the #3 fence section may be connected, the #3 fence section and the #4 fence section may be connected, and so on, until the #8 fence section and the #1 fence section are connected.

It should be noted that the above example where eight first limiting holes 20 and eight second limiting holes 21 are provided is merely an embodiment, the number of the first limiting holes 20 and the number of the second limiting holes 21 may also be 4, 6, 10, etc., and the number of the first limiting holes 20 may also be different from the number of the second limiting holes 21, so that different angles can be formed between two adjacent fence sections. The specific mounting principle is the same as that of the case where eight first limiting holes 20 and eight second limiting holes 21 are provided, so the details will not be elaborated herein.

The above mounting method allows for the adjustment of the angle between two adjacent fence sections, enabling the shape of the mounted pet fence to adapt to rooms or other spaces of different shapes, thereby expanding the range of applications of the pet fence. Moreover, the above mounting process is simple and convenient, and can be easily achieved by pulling the second horizontal tube 2 upward, adjusting the angle between two adjacent fence sections, and inserting the limiting rods 22 into the corresponding first limiting holes 20 and the corresponding second limiting holes 21.

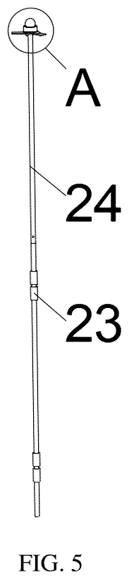

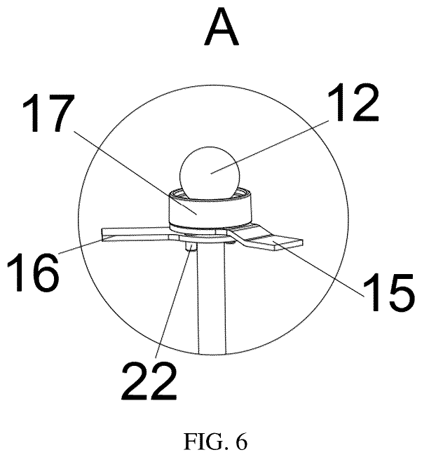

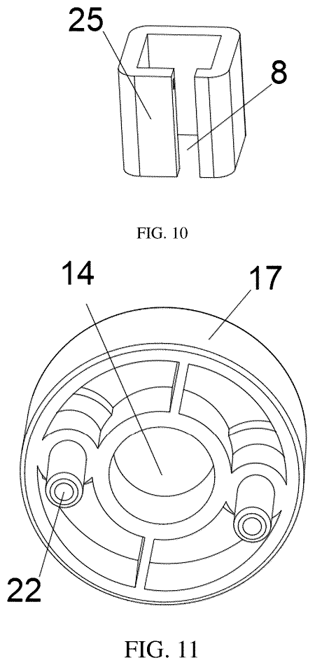

As shown in FIG. 1, FIG. 2, FIG. 5, FIG. 6, and FIG. 11, in an embodiment of the present disclosure, each of the connection assemblies further includes two connecting tubes 23, a second through hole 14, a connecting rod 24, and a second limiting member 12.

The two connecting tubes 23 are fixedly connected to a side of each of two adjacent first vertical tubes 3 of the two adjacent fence sections away from a respective one of the first horizontal tube 1 of one of the two adjacent fence sections and the first horizontal tube 1 of the other of the two adjacent fence sections.

The second through hole 14 is provided on the third connection member 17.

The connecting rod 24 is arranged between the two adjacent fence sections. The connecting rod 24 is configured to pass through the second through hole 14, the first connecting hole 18, the second connecting hole 19, and the corresponding connecting tubes 23. The connecting rod 24 is telescopic. The limiting mode of the connecting rod 24 is the same as the limiting mode of the first vertical tube 3 and the second vertical tube 4, i.e., the extended connecting rod 24 is fixed by the first limiting member 11. The specific working principle will not be detailed herein again.

The second limiting member 12 is arranged above the third connection member 17. The second limiting member 12 is fixedly connected to the connecting rod 24. An outer diameter of the second limiting member 12 is larger than an inner diameter of the second through hole 14.

After the angle between two adjacent fence sections is fixed, since the two connecting tubes 23 are fixedly connected to a side of each first vertical tube 3 away from the respective first horizontal tube 1, four connecting tubes 23 are arranged between the two adjacent fence sections. The connecting tubes 23 have different heights in the vertical direction, so that the connecting rod 24 passes through the second through hole 14, the first connecting hole 18, the second connecting hole 19, and the four connecting tubes 23 between the two adjacent fence sections sequentially from top to bottom. The connecting rod 24 passing through the four connecting tubes 23 can improve the stability of the two adjacent fence sections. The second limiting member 12 is arranged above the third connection member 17, the second limiting member 12 is fixedly connected to an upper end of the connecting rod 24, and the outer diameter of the second limiting member 12 is larger than the inner diameter of the second through hole 14, which can limit the connecting rod 24 and allow a user to easily pull the connecting rod 24 upward in the disassembly process.

As shown in FIG. 10, in an embodiment of the present disclosure, each of the plurality of fence sections further includes protective members 25.

Each of the protective members 25 is fixedly connected to an upper end of a respective one of the two first vertical tubes 3, the two second vertical tubes 4 respectively pass through the protective members 25, and a second slide groove 8 is provided on a side of each of the protective members 25 adjacent to the first metal mesh 5.

When the first vertical tube 3 is made of metal, a hand of the user may be injured by the upper end of the first vertical tube 3 during the mounting process. Therefore, the arrangement of the protective members 25, which may be made of a soft material, can prevent the user from being injured. The second slide groove 8 is provided on the side of the protective member 25 adjacent to the first metal mesh 5, and the second slide groove 8 and the first slide groove 7 are on the same vertical line, to ensure that the first metal mesh 5 can smoothly pass through the protective member 25 when moving upward.

### Embodiment 2

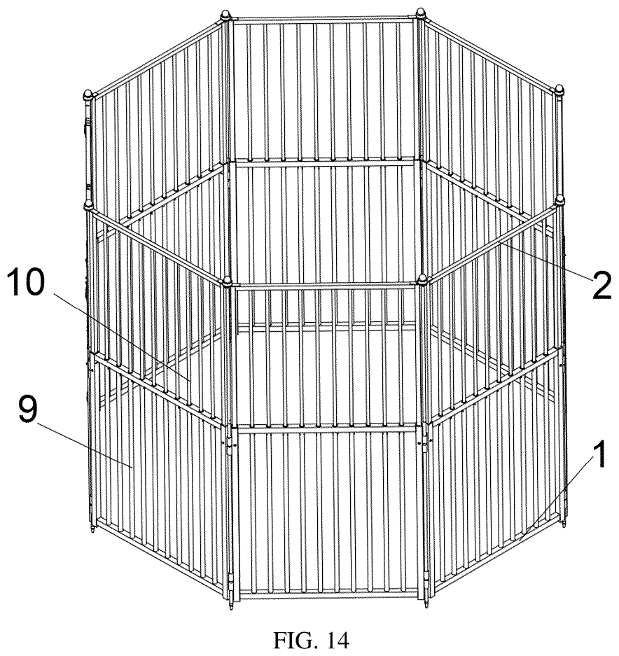

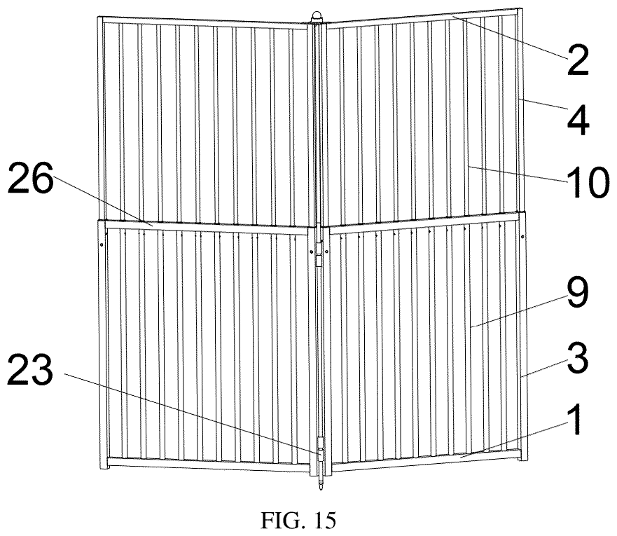

As shown in FIG. 7, FIG. 8, FIG. 9, FIG. 14, and FIG. 15, in an embodiment of the present disclosure, each of the plurality of fence sections includes:

a first horizontal tube 1;

two first vertical tubes 3, where lower ends of the two first vertical tubes 3 are respectively connected to two ends of the first horizontal tube 1;

two second vertical tubes 4, where the two second vertical tubes 4 are slidably connected to interiors of the two first vertical tubes 3 respectively; and

a second horizontal tube 2, where two ends of the second horizontal tube 2 are fixedly connected to upper ends of the two second vertical tubes 4 respectively.

Each of the plurality of fence sections further includes:

first metal tubes 9, where a lower end of each of the first metal tubes 9 is fixedly connected to an upper surface of the first horizontal tube 1; and

second metal tubes 10, where an upper end of each of the second metal tubes 10 is fixedly connected to a lower surface of the second horizontal tube 2, and the second metal tubes 10 are slidably connected to interiors of the first metal tubes 9 respectively.

Each of the limiting assemblies includes first limiting members 11 and first through holes 13.

Each of the first limiting members 11 may be a V-shaped elastic piece. The V-shaped elastic piece is fixedly connected to an interior of a respective second vertical tube 4 of the two second vertical tubes 4. A protrusion is fixedly connected to the V-shaped elastic piece. The protrusion penetrates the respective second vertical tube 4.

The first through holes 13 are respectively provided on the two first vertical tubes 3. The protrusion on the V-shaped elastic piece is arranged opposite to a respective one of the first through holes 13.

The door assembly includes:

a third horizontal tube 30, where the third horizontal tube 30 is arranged on an inner side of the access opening, and two ends of the third horizontal tube 30 are fixedly connected to portions of the first horizontal tube 1 of the one of the plurality of fence sections on two sides of the access opening respectively;

a fourth horizontal tube 31, where the fourth horizontal tube 31 is arranged on the inner side of the access opening, and two ends of the fourth horizontal tube 31 are fixedly connected to portions of the second horizontal tube 2 of the one of the plurality of fence sections on the two sides of the access opening respectively; and

a rotary door 32, where a lower end and an upper end of the rotary door 32 are rotatably connected to the third horizontal tube 30 and the fourth horizontal tube 31 respectively.

The door assembly further includes:

a plurality of first supporting rods 33, where the plurality of first supporting rods 33 are arranged on two sides of the rotary door 32, a lower end of each of the plurality of first supporting rods 33 is fixedly connected to the third horizontal tube 30, and a slide rail is provided in each of the plurality of first supporting rods 33;

a plurality of second supporting rods 34, where the plurality of second supporting rods 34 are arranged on the two sides of the rotary door 32, an upper end of each of the plurality of second supporting rods 34 is fixedly connected to the fourth horizontal tube 31, and a lower end of each of the plurality of second supporting rods 34 is slidably connected to the slide rail in a respective one of the plurality of first supporting rods 33; and

a locking member 35, where the locking member 35 is threadedly connected to an outer wall of a first supporting rod 33 of the plurality of first supporting rods 33.

Before the pet fence is mounted, the two second vertical tubes 4 are respectively arranged in the two first vertical tubes 3, and the second metal tubes 10 are respectively arranged in the first metal tubes 9. In this case, a length of the entire structure of the fence section is less than a length of the fence section when in use, so that the storage space required by the fence sections can be reduced and space utilization can be improved.

To mount the pet fence, the second horizontal tube 2 is pulled upward to drive the second vertical tubes 4 and the second metal tubes 10 to slide upward. During the upward movement of the second vertical tube 4, because the protrusion penetrates the second vertical tube 4 and is in contact with an inner wall of the first vertical tube 3, and the V-shaped elastic piece is always in a compressed state and applies a force to the protrusion during the upward sliding of the second vertical tube 4, the protrusion applies a force to the first vertical tube 3. Then, when a lower end of the second vertical tube 4 is about to reach an upper end of the first vertical tube 3, the protrusion moves to the first through hole 13, and the V-shaped elastic piece restores to the original shape and drives the protrusion to pass through the first through hole 13. As such, the second vertical tube 4 can be fixed through the engagement of the first through hole 13 with the protrusion to prevent the second vertical tube 4 from moving relative to the first vertical tube 3, thereby improving the stability of the first vertical tube 3 and the second vertical tube 4. When a surface of the protrusion is an arc-shaped surface, the second horizontal tube 2 may be directly pushed downward. After the protrusion is compressed, the protrusion compresses the V-shaped elastic piece, and the protrusion enters the second vertical tube 4 again through the through hole. Then, the second horizontal tube 2 is further pushed downward, and the second vertical tube 4 will enter the first vertical tube 3 again.

In the process of pulling the second horizontal tube 2 upward, the second horizontal tube 2 drives the fourth horizontal tube 31 to move upward, and the fourth horizontal tube 31 drives the second supporting rods 34 to move upward. The rotary door 32 is telescopic. The principles of extension and retraction of the rotary door 32 are the same as those of the fence section, so the details will not be described herein again. As such, in the process of pulling the second horizontal tube 2 upward, the rotary door 32 can be driven to extend. After the entire pet fence is mounted, a pet can enter and exit the pet fence through the rotary door 32.

After the position of the rotary door 32 is determined, the locking member 35 may be rotated. The locking member 35 may be a screw. The screw may be rotated to penetrate a side wall of the first supporting rod 33 and extend into the slide rail, so that an end portion of the screw comes into contact with the second supporting rod 34. After the screw is tightened, the second supporting rod 34 can be fixed by the screw to prevent the second supporting rod 34 from loosening.

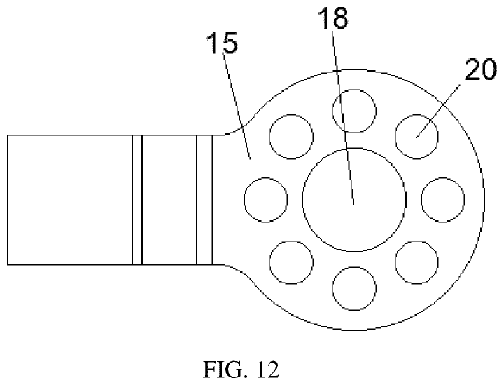

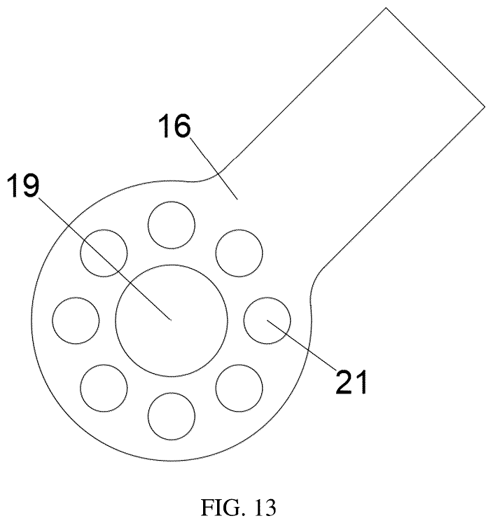

As shown in FIG. 5, FIG. 6, FIG. 11, FIG. 12, and FIG. 13, in an embodiment of the present disclosure, each of the connection assemblies includes a first connection member 15, a second connection member 16, a third connection member 17, and two limiting rods 22.

The first connection member 15 is fixedly connected to an adjacent end of the second horizontal tube 2 of one of the two adjacent fence sections. The first connection member 15 includes a first rectangular piece and a first round piece. The first rectangular piece is fixedly connected to the adjacent end of the second horizontal tube 2. The first round piece is not in contact with the second horizontal tube 2. A first connecting hole 18 is provided in a middle portion of the first round piece. A plurality of first limiting holes 20 are provided on the first round piece. The plurality of first limiting holes 20 are arranged at equal intervals along a circumferential direction of the first connecting hole 18.

The second connection member 16 is fixedly connected to an adjacent end of the second horizontal tube 2 of the other of the two adjacent fence sections. The second connection member 16 includes a second rectangular piece and a second round piece. The second rectangular piece is fixedly connected to the adjacent end of the second horizontal tube 2. The second round piece is not in contact with the second horizontal tube 2. A second connecting hole 19 is provided in a middle portion of the second round piece. The second round piece is provided with a plurality of second limiting holes 21. The plurality of second limiting holes 21 are arranged at equal intervals along a circumferential direction of the second connecting hole 19.

The third connection member 17 is arranged between the two adjacent fence sections. The third connection member 17 is arranged on a side of the first connection member 15 and the second connection member 16 away from the first horizontal tube 1.

The two limiting rods 22 are fixedly connected to a side of the third connection member 17 adjacent to the first horizontal tube 1. Each of the two limiting rods 22 is configured to pass through one of the plurality of first limiting holes 20 and one of the plurality of second limiting holes 21.

After the mounting of the first vertical tubes 3 and the second vertical tubes 4 is completed, for example, the pet fence of the present disclosure includes eight fence sections, namely, a #1 fence section, a #2 fence section, a #3 fence section, a #4 fence section, a #5 fence section, a #6 fence section, a #7 fence section, and a #8 fence section. Second horizontal tubes 2 of the #1 fence section, the #2 fence section, the #3 fence section, the #4 fence section, the #5 fence section, the #6 fence section, the #7 fence section, and the #8 fence section are respectively defined as a #1 second horizontal tube 2, a #2 second horizontal tube 2, a #3 second horizontal tube 2, a #4 second horizontal tube 2, a #5 second horizontal tube 2, a #6 second horizontal tube 2, a #7 second horizontal tube 2, and a #8 second horizontal tube 2. When the eight fence sections are mounted, the first round piece on the #1 second horizontal tube 2 and the second round piece on the #2 second horizontal tube 2 are stacked together in a vertical direction. The first round piece is arranged on an upper surface of the second round piece. The shape and size of the first round piece are the same as the shape and size of the second round piece. The shape, size, and number of the first connecting hole(s) 18 on the first round piece are the same as the shape, size, and number of the second connecting hole(s) 19 on the second round piece. The shape, size, and number of the first limiting holes 20 on the first round piece are the same as the shape, size, and number of the second limiting holes 21 on the second round piece. For example, in the present disclosure, eight first limiting holes 20 and eight second limiting holes 21 are provided. An angle formed by two lines respectively connecting a circle center of the first connecting hole 18 to circle centers of two adjacent first limiting holes 20 is 45 degrees. The #1 fence section and the #2 fence section are arranged side by side, so that the #1 fence section and the #2 fence section are on the same straight line. In this case, an angle formed by the #1 fence section and the #2 fence section is 180 degrees, and the eight first limiting holes 20 are respectively opposite to the eight second limiting holes 21 in the vertical direction. Each of the two limiting rods 22 on the third connection member 17 is passed through one pair of the first limiting hole 20 and the second limiting hole 21 that are opposite to each other. Through the respective engagement of the two limiting rods 22 with two pairs of the first limiting holes 20 and the second limiting holes 21, the first round piece and the second round piece can be limited from moving relative to each other, and the angle formed by the #1 fence section and the #2 fence section can be set to 180 degrees. As such, the stability of connection between the #1 fence section and the #2 fence section is improved, and the #1 fence section and the #2 fence section are prevented from moving relative to each other. In addition, the angle between the #1 fence section and the #2 fence section may also be 135 degrees, which can be achieved by rotating the #1 fence section toward the #2 fence section by 45 degrees based on the case where the angle between the #1 fence section and the #2 fence section is 180 degrees. In this case, the eight first limiting holes 20 are also respectively opposite to the eight second limiting holes 21, and the two limiting rods 22 may be respectively inserted into two pairs of the first limiting holes 20 and the second limiting holes 21 that are opposite to each other. Similarly, the angle formed by the #1 fence section and the #2 fence section may also be set to 90 degrees or 45 degrees. Then, by the above mounting method, the #2 fence section and the #3 fence section may be connected, the #3 fence section and the #4 fence section may be connected, and so on, until the #8 fence section and the #1 fence section are connected.

It should be noted that the above example where eight first limiting holes 20 and eight second limiting holes 21 are provided is merely an embodiment, the number of the first limiting holes 20 and the number of the second limiting holes 21 may also be 4, 6, 10, etc., and the number of the first limiting holes 20 may also be different from the number of the second limiting holes 21, so that different angles can be formed between two adjacent fence sections. The specific mounting principle is the same as that of the case where eight first limiting holes 20 and eight second limiting holes 21 are provided, so the details will not be elaborated herein.

The above mounting method allows for the adjustment of the angle between two adjacent fence sections, enabling the shape of the mounted pet fence to adapt to rooms or other spaces of different shapes, thereby expanding the range of applications of the pet fence. Moreover, the above mounting process is simple and convenient, and can be easily achieved by pulling the second horizontal tube 2 upward, adjusting the angle between two adjacent fence sections, and inserting the limiting rods 22 into the corresponding first limiting holes 20 and the corresponding second limiting holes 21.

As shown in FIG. 3, FIG. 14, and FIG. 15, in an embodiment of the present disclosure, each of the connection assemblies further includes two connecting tubes 23, a second through hole 14, a connecting rod 24, and a second limiting member 12.

The two connecting tubes 23 are fixedly connected to a side of each of two adjacent first vertical tubes 3 of the two adjacent fence sections away from a respective one of the first horizontal tube 1 of one of the two adjacent fence sections and the first horizontal tube 1 of the other of the two adjacent fence sections.

The second through hole 14 is provided on the third connection member 17.

The connecting rod 24 is arranged between the two adjacent fence sections. The connecting rod 24 is configured to pass through the second through hole 14, the first connecting hole 18, the second connecting hole 19, and the corresponding connecting tubes 23.

The second limiting member 12 is arranged above the third connection member 17. The second limiting member 12 is fixedly connected to the connecting rod 24. An outer diameter of the second limiting member 12 is larger than an inner diameter of the second through hole 14.

After the angle between two adjacent fence sections is fixed, since the two connecting tubes 23 are fixedly connected to a side of each first vertical tube 3 away from the respective first horizontal tube 1, four connecting tubes 23 are arranged between the two adjacent fence sections. The connecting tubes 23 have different heights in the vertical direction, so that the connecting rod 24 passes through the second through hole 14, the first connecting hole 18, the second connecting hole 19, and the four connecting tubes 23 between the two adjacent fence sections sequentially from top to bottom. The connecting rod 24 passing through the four connecting tubes 23 can improve the stability of the two adjacent fence sections. The second limiting member 12 is arranged above the third connection member 17, the second limiting member 12 is fixedly connected to an upper end of the connecting rod 24, and the outer diameter of the second limiting member 12 is larger than the inner diameter of the second through hole 14, which can limit the connecting rod 24 and allow a user to easily pull the connecting rod 24 upward in the disassembly process.

As shown in FIG. 14 and FIG. 15, in an embodiment of the present disclosure, each of the plurality of fence sections further includes a fixing member 26.

Two ends of the fixing member 26 are respectively connected to the two first vertical tubes 3, and the first metal tubes 9 pass through the fixing member 26.

The fixing member 26 can improve the stability of the first metal tubes 9, thereby preventing the first metal tubes 9 from shaking.

### Embodiment 3

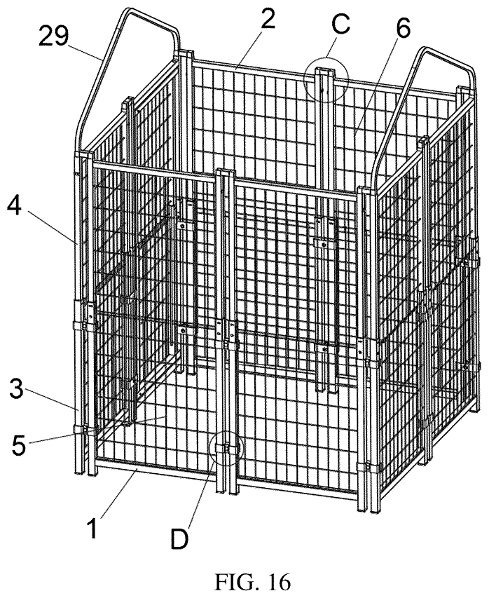

As shown in FIG. 16 to FIG. 18, in an embodiment of the present disclosure, each of the plurality of fence sections includes:

a first horizontal tube 1;

two first vertical tubes 3, where lower ends of the two first vertical tubes 3 are respectively connected to two ends of the first horizontal tube 1;

two second vertical tubes 4, where the two second vertical tubes 4 are slidably connected to interiors of the two first vertical tubes 3 respectively; and

a second horizontal tube 2, where two ends of the second horizontal tube 2 are fixedly connected to upper ends of the two second vertical tubes 4 respectively.

Each of the plurality of fence sections further includes:

a first metal mesh 5, where two ends of the first metal mesh 5 in a horizontal direction are fixedly connected to opposing surfaces of the two first vertical tubes 3 respectively, and a lower end of the first metal mesh 5 is fixedly connected to an upper end of the first horizontal tube 1;

a second metal mesh 6, where two ends of the second metal mesh 6 in the horizontal direction are fixedly connected to opposing surfaces of the two second vertical tubes 4 respectively, and an upper end of the second metal mesh 6 is fixedly connected to a lower end of the second horizontal tube 2; and

first slide grooves 7, where the first slide grooves 7 are respectively provided on the opposing surfaces of the two first vertical tubes 3.

Each of the limiting assemblies includes first limiting members 11 and first through hole 13.

Each of the first limiting members 11 may be a V-shaped elastic piece. The V-shaped elastic piece is fixedly connected to an interior of a respective second vertical tube 4 of the two second vertical tubes 4. A protrusion is fixedly connected to the V-shaped elastic piece. The protrusion penetrates the respective second vertical tube 4.

The first through holes 13 are respectively provided on the two first vertical tubes 3. The protrusion on the V-shaped elastic piece is arranged opposite to a respective one of the first through holes 13.

The door assembly includes:

a third horizontal tube 30, where the third horizontal tube 30 is arranged on an inner side of the access opening, and two ends of the third horizontal tube 30 are fixedly connected to portions of the first horizontal tube 1 of the one of the plurality of fence sections on two sides of the access opening respectively;

a fourth horizontal tube 31, where the fourth horizontal tube 31 is arranged on the inner side of the access opening, and two ends of the fourth horizontal tube 31 are fixedly connected to portions of the second horizontal tube 2 of the one of the plurality of fence sections on the two sides of the access opening respectively; and

a rotary door 32, where a lower end and an upper end of the rotary door 32 are rotatably connected to the third horizontal tube 30 and the fourth horizontal tube 31 respectively.

The door assembly further includes:

a plurality of first supporting rods 33, where the plurality of first supporting rods 33 are arranged on two sides of the rotary door 32, a lower end of each of the plurality of first supporting rods 33 is fixedly connected to the third horizontal tube 30, and a slide rail is provided in each of the plurality of first supporting rods 33;

a plurality of second supporting rods 34, where the plurality of second supporting rods 34 are arranged on the two sides of the rotary door 32, an upper end of each of the plurality of second supporting rods 34 is fixedly connected to the fourth horizontal tube 31, and a lower end of each of the plurality of second supporting rods 34 is slidably connected to the slide rail in a respective one of the plurality of first supporting rods 33; and

a locking member 35, where the locking member 35 is threadedly connected to an outer wall of a first supporting rod 33 of the plurality of first supporting rods 33.

Before the pet fence is mounted, the two second vertical tubes 4 are respectively arranged in the two first vertical tubes 3, the two ends of the second metal mesh 6 respectively pass through the first slide grooves 7 on the opposing surfaces of the two first vertical tubes 3, and the two ends of the second metal mesh 6 respectively extend into the two first slide grooves 7. In this case, a length of the entire structure of the fence section is less than a length of the fence section when in use, so that the storage space required by the fence sections can be reduced and space utilization can be improved.

To mount the pet fence, the second horizontal tube 2 is pulled upward to drive the second vertical tubes 4 to slide upward, and at the same time, cause the second metal mesh 6 to slide upward along the first slide grooves 7. During the upward movement of the second vertical tube 4, because the protrusion penetrates the second vertical tube 4 and is in contact with an inner wall of the first vertical tube 3, and the V-shaped elastic piece is always in a compressed state and applies a force to the protrusion during the upward sliding of the second vertical tube 4, the protrusion applies a force to the first vertical tube 3. Then, when a lower end of the second vertical tube 4 is about to reach an upper end of the first vertical tube 3, the protrusion moves to the first through hole 13, and the V-shaped elastic piece restores to the original shape and drives the protrusion to pass through the first through hole 13. As such, the second vertical tube 4 can be fixed through the engagement of the first through hole 13 with the protrusion to prevent the second vertical tube 4 from moving relative to the first vertical tube 3, thereby improving the stability of the first vertical tube 3 and the second vertical tube 4. When a surface of the protrusion is an arc-shaped surface, the second horizontal tube 2 may be directly pushed downward. After the protrusion is compressed, the protrusion compresses the V-shaped elastic piece, and the protrusion enters the second vertical tube 4 again through the through hole. Then, the second horizontal tube 2 is further pushed downward, and the second vertical tube 4 will enter the first vertical tube 3 again.

In the process of pulling the second horizontal tube 2 upward, the second horizontal tube 2 drives the fourth horizontal tube 31 to move upward, and the fourth horizontal tube 31 drives the second supporting rods 34 to move upward. The rotary door 32 is telescopic. The principles of extension and retraction of the rotary door 32 are the same as those of the fence section, so the details will not be described herein again. As such, in the process of pulling the second horizontal tube 2 upward, the rotary door 32 can be driven to extend. After the entire pet fence is mounted, a pet can enter and exit the pet fence through the rotary door 32.

After the position of the rotary door 32 is determined, the locking member 35 may be rotated. The locking member 35 may be a screw. The screw may be rotated to penetrate a side wall of the first supporting rod 33 and extend into the slide rail, so that an end portion of the screw comes into contact with the second supporting rod 34. After the screw is tightened, the second supporting rod 34 can be fixed by the screw to prevent the second supporting rod 34 from loosening.

As shown in FIG. 1 to FIG. 4 as well as FIG. 9 to FIG. 11, in an embodiment of the present disclosure, the connection assemblies respectively include:

fourth connection members 27, where each of the fourth connection members 27 is arranged between the two adjacent fence sections, each of the fourth connection members 27 is U-shaped, two ends of each of the fourth connection members 27 are respectively inserted into ends of two adjacent second vertical tubes 4 of the two adjacent fence sections away from the first horizontal tube 1, the two ends of each of the fourth connection members 27 each have a square cross section, and a shape of each of the two ends of each of the fourth connection members 27 conforms to a shape of a cross section of each second vertical tube 4; and

fifth connection members 28, where each of the fifth connection members 28 is arranged between the two adjacent fence sections, and two adjacent first vertical tubes 3 of the two adjacent fence sections pass through each of the fifth connection members 28. Each of the fifth connection members 28 includes two clamp plates.

The pet fence further includes:

at least two supporting members 29, where two ends of each of the at least two supporting members 29 are respectively connected to two of the fourth connection members 27, and the at least two supporting members 29 are parallel to each other.

For example, the pet fence of the present disclosure includes eight fence sections, namely, a #1 fence section, a #2 fence section, a #3 fence section, a #4 fence section, a #5 fence section, a #6 fence section, a #7 fence section, and a #8 fence section. After the mounting of the first vertical tubes 3 and the second vertical tubes 4 is completed, the eight fence sections are connected end to end in sequence to form a pet fence which is rectangular when viewed from above. Because head ends and tail ends of the #1 fence section, the #2 fence section, the #3 fence section, the #4 fence section, the #5 fence section, the #6 fence section, the #7 fence section, and the #8 fence section are each provided with one second vertical tube 4, the two second vertical tubes 4 of the #1 fence section are respectively defined as a #1 head-end second vertical tube 4 and a #1 tail-end second vertical tube 4, the two second vertical tubes 4 of the #2 fence section are respectively defined as a #2 head-end second vertical tube 4 and a #2 tail-end second vertical tube 4, the two second vertical tubes 4 of the #3 fence section are respectively defined as a #3 head-end second vertical tube 4 and a #3 tail-end second vertical tube 4, the two second vertical tubes 4 of the #4 fence section are respectively defined as a #4 head-end second vertical tube 4 and a #4 tail-end second vertical tube 4, the two second vertical tubes 4 of the #5 fence section are respectively defined as a #5 head-end second vertical tube 4 and a #5 tail-end second vertical tube 4, the two second vertical tubes 4 of the #6 fence section are respectively defined as a #6 head-end second vertical tube 4 and a #6 tail-end second vertical tube 4, the two second vertical tubes 4 of the #7 fence section are respectively defined as a #7 head-end second vertical tube 4 and a #7 tail-end second vertical tube 4, and the two second vertical tubes 4 of the #8 fence section are respectively defined as a #8 head-end second vertical tube 4 and a #8 tail-end second vertical tube 4. The two ends of the fourth connection member 27 are respectively inserted into an upper end of the #1 tail-end second vertical tube 4 and an upper end of the #2 head-end second vertical tube 4 to connect the #1 fence section and the #2 fence section together. Because the fifth connection member 28 includes two clamp plates, the two adjacent first vertical tubes 3 of the #1 fence section and the #2 fence section are clamped with the two clamp plates, and then a screw is threadedly connected to the two clamp plates. After the screw is tightened, the #1 fence section and the #2 fence section can be fixed by the two clamp plates. As such, the #1 fence section and the #2 fence section can be fixed by the fourth connection member 27 and the fifth connection member 28. Based on the same principle, the tail end of the #2 fence section is connected to the head end of the #3 fence section, the tail end of the #3 fence section is connected to the head end of the #4 fence section, the tail end of the #4 fence section is connected to the head end of the #5 fence section, the tail end of the #5 fence section is connected to the head end of the #6 fence section, the tail end of the #6 fence section is connected to the head end of the #7 fence section, the tail end of the #7 fence section is connected to the head end of the #8 fence section, and the tail end of the #8 fence section is connected to the head end of the #1 fence section. Because the shape of the cross section of each end of the fourth connection member 27 is square, the angle between two adjacent fence sections can only be 90 degrees or 180 degrees. Therefore, the fence sections can be connected to form a pet fence which is rectangular when viewed from above.

It should be noted that the arrangement of eight fence sections in the present disclosure is merely an example, and other numbers of fence sections may also be used according to actual usage requirements.

When the connection of all the fence sections of the pet fence is completed, two supporting members 29 symmetrical to each other are arranged on an upper part of the pet fence. The two supporting members 29 are respectively arranged at two ends of the upper part of the pet fence. The supporting members 29 are U-shaped. A distance between the two ends of each supporting member 29 is the same as a width of the pet fence. Connecting grooves are provided on an upper surface of each of the fourth connection members 27. The two ends of each supporting member 29 are inserted into the corresponding connecting grooves, so that the two supporting members 29 are symmetrical to each other. A protective film may be provided above the pet fence to cover the pet fence. The protective film is supported by the two supporting members 29. Compared with directly placing the protective film on the second horizontal tube 2, mounting the protective film on the supporting members 29 provides improved aesthetics.

The above mounting process is simple and convenient, and can be easily achieved by pulling the second horizontal tube 2 upward, inserting the fourth connection member 27 into the upper ends of two adjacent second vertical tubes 4, and then clamping two adjacent first vertical tubes 3 with the fifth connection member 28.

The present disclosure has the following advantages.

1. The configuration of the telescopic fence sections may reduce storage space and improve space utilization.

2. The limiting assemblies arranged in the fence sections may limit the fence sections when the pet fence is in use, thereby improving the stability of the fence sections. In addition, the limiting assemblies do not require user operation, so that the mounting difficulty is reduced for the user.

3. Through the arrangement of the connection assembly between two adjacent fence sections, not only the two adjacent fence sections may be connected by the connection assembly, but also the angle formed by the two adjacent fence sections may be adjusted, so that the pet fence may be formed into different shapes to adapt to rooms or other spaces of different shapes, thereby improving the practicability of the pet fence.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A pet fence, comprising:
a plurality of fence sections, wherein the plurality of fence sections are connected end to end in sequence to define an accommodating space, an access opening is provided on one of the plurality of fence sections, and the plurality of fence sections are telescopic;
a door assembly, wherein the door assembly is connected to the access opening;
limiting assemblies, wherein the limiting assemblies are respectively arranged in the plurality of fence sections; and
connection assemblies, wherein each of the connection assemblies is arranged between two adjacent fence sections of the plurality of fence sections.

2. The pet fence according to claim 1, wherein
each of the plurality of fence sections comprises:
a first horizontal tube;
two first vertical tubes, wherein an end of each of the two first vertical tubes is connected to the first horizontal tube;
two second vertical tubes, wherein the two second vertical tubes are slidably connected to interiors of the two first vertical tubes respectively; and
a second horizontal tube, wherein the second horizontal tube is connected to an end of each of the two second vertical tubes away from the first horizontal tube.

3. The pet fence according to claim 2, wherein each of the plurality of fence sections further comprises:
a first metal mesh, wherein the first metal mesh is connected between the two first vertical tubes;
a second metal mesh, wherein the second metal mesh is connected between the two second vertical tubes; and
first slide grooves, wherein the first slide grooves are respectively provided on opposing surfaces of the two first vertical tubes.

4. The pet fence according to claim 2, wherein each of the plurality of fence sections further comprises:
a first metal tube, wherein an end of the first metal tube is connected to the first horizontal tube; and
a second metal tube, wherein an end of the second metal tube is connected to the second horizontal tube, and the second metal tube is slidably connected to an interior of the first metal tube.

5. The pet fence according to claim 2, wherein
each of the limiting assemblies comprises:
first limiting members, wherein the first limiting members are fixedly connected to interiors of the two second vertical tubes respectively, and the first limiting members penetrate the two second vertical tubes respectively; and
first through holes, wherein the first through holes are respectively provided on the two first vertical tubes, and the first limiting members are respectively arranged opposite to the first through holes.

6. The pet fence according to claim 2, wherein
each of the connection assemblies comprises:
a first connection member, wherein the first connection member is connected to an adjacent end of the second horizontal tube of one of the two adjacent fence sections, a first connecting hole is provided on the first connection member, a plurality of first limiting holes are provided on the first connection member, and the plurality of first limiting holes are arranged along a circumferential direction of the first connecting hole;
a second connection member, wherein the second connection member is connected to an adjacent end of the second horizontal tube of the other of the two adjacent fence sections, a second connecting hole is provided on the second connection member, a plurality of second limiting holes are provided on the second connection member, and the plurality of second limiting holes are arranged along a circumferential direction of the second connecting hole;
a third connection member, wherein the third connection member is arranged between the two adjacent fence sections, and the third connection member is arranged on a side of the first connection member and the second connection member away from the first horizontal tube; and
at least two limiting rods, wherein the at least two limiting rods are connected to a side of the third connection member adjacent to the first horizontal tube, and each of the at least two limiting rods is configured to pass through one of the plurality of first limiting holes and one of the plurality of second limiting holes.

7. The pet fence according to claim 6, wherein each of the connection assemblies further comprises:
at least one connecting tube, wherein the at least one connecting tube is connected to a side of each of two adjacent first vertical tubes of the two adjacent fence sections away from a respective one of the first horizontal tube of one of the two adjacent fence sections and the first horizontal tube of the other of the two adjacent fence sections;
a second through hole, wherein the second through hole is provided on the third connection member;
a connecting rod, wherein the connecting rod is arranged between the two adjacent fence sections, and the connecting rod is configured to pass through the second through hole, the first connecting hole, the second connecting hole, and the at least one connecting tube; and
a second limiting member, wherein the second limiting member is arranged on a side of the third connection member away from the first horizontal tube, the second limiting member is connected to the connecting rod, and an outer diameter of the second limiting member is larger than an inner diameter of the second through hole.

8. The pet fence according to claim 3, wherein each of the plurality of fence sections further comprises:
protective members, wherein each of the protective members is connected to an end of a respective one of the two first vertical tubes away from the first horizontal tube, the two second vertical tubes respectively pass through the protective members, and a second slide groove is provided on a side of each of the protective members adjacent to the first metal mesh.

9. The pet fence according to claim 4, wherein each of the plurality of fence sections further comprises:
a fixing member, wherein two ends of the fixing member are respectively connected to the two first vertical tubes, and the first metal tube passes through the fixing member.

10. The pet fence according to claim 2, wherein
the connection assemblies respectively comprise:
fourth connection members, wherein each of the fourth connection members is arranged between the two adjacent fence sections, and two ends of each of the fourth connection members are respectively inserted into ends of two adjacent second vertical tubes of the two adjacent fence sections away from the first horizontal tube; and
fifth connection members, wherein each of the fifth connection members is arranged between the two adjacent fence sections, and two adjacent first vertical tubes of the two adjacent fence sections pass through each of the fifth connection members.

11. The pet fence according to claim 10, further comprising:
at least two supporting members, wherein two ends of each of the at least two supporting members are respectively connected to two of the fourth connection members, and the at least two supporting members are parallel to each other.

12. The pet fence according to claim 3, wherein
the door assembly comprises:
a third horizontal tube, wherein the third horizontal tube is arranged on an inner side of the access opening, and the third horizontal tube is connected to the first horizontal tube of the one of the plurality of fence sections;
a fourth horizontal tube, wherein the fourth horizontal tube is arranged on the inner side of the access opening, and the fourth horizontal tube is connected to the second horizontal tube of the one of the plurality of fence sections; and
a rotary door, wherein two ends of the rotary door are rotatably connected to the third horizontal tube and the fourth horizontal tube respectively.

13. The pet fence according to claim 12, wherein the door assembly further comprises:
a plurality of first supporting rods, wherein the plurality of first supporting rods are arranged on two sides of the rotary door, and an end of each of the plurality of first supporting rods is connected to the third horizontal tube;
a plurality of second supporting rods, wherein the plurality of second supporting rods are arranged on the two sides of the rotary door, a first end of each of the plurality of second supporting rods is connected to the fourth horizontal tube, and a second end of each of the plurality of second supporting rods is slidably connected to an interior of a respective one of the plurality of first supporting rods; and
a locking member, wherein the locking member is threadedly connected to an outer wall of a first supporting rod of the plurality of first supporting rods.
